(19) United States
(12) Patent Application Publication
(10) Pub. No.: US 2015/0196144 A1
(43) Pub. Date: Jul. 16, 2015

(54) COMPACTABLE MIRROR FRAME

(71) Applicant: Shelby Mathew, Fort Lauderdale, FL (US)

(72) Inventor: Shelby Mathew, Fort Lauderdale, FL (US)

(21) Appl. No.: 14/154,186

(22) Filed: Jan. 14, 2014

(51) Int. Cl. A47G 1/06; B65D 85/00; B27B 27/00; G02B 7/182

(52) U.S. Cl. CPC A47G 1/0616; G02B 7/182; B65D 85/70; B27B 27/00; A47G 2001/005

(57) ABSTRACT

A decorative compactable mirror frame is disclosed for use on pre-mounted mirrors with or without mirror clips. The frame members of the frame can be rolled up and/or segmented so as to be packageable within a convenient box, and then easily be taken home and installed by a consumer. Frame members can also be sold separately. Each frame member has an adhesive backing strip such that a portion of the back side of each frame member can be mounted upon the pre-mounted mirror. Each frame member can also have a cushioned channel for accommodating mirror clips, the cushion material substantially filling the channel so as to substantially exclude and/or inhibit insect and/or microbial activity. The compact mirror frame can be sold as a kit including at least four compacted frame members, along with at least a cutting tool, and/or a miter box, and/or four corner blocks.

### CROSS-REFERENCE TO RELATED APPLICATIONS

This application derives priority from the provisional patent application 61/807,555, filed Apr. 2, 2013, entitled “Flexible and Rollable Frame Border”, the entire contents of which is incorporated herein by reference.

### FIELD OF THE INVENTION

This invention relates to frames, and particularly to frames for mirrors.

### BACKGROUND OF THE INVENTION

Mirrors are a standard vanity item found in nearly all homes and businesses. Although mirrors can be placed in any room, they are typically found in bathrooms, hallways, and bedrooms. They can be either framed or unframed, but having a framed mirror is often desired as it increases the decorative appeal of the mirror and enhances the aesthetics of a room.

Various styles of framed mirrors can be obtained in most sizes and designs for purchase at many retail stores. But many homes and businesses often have pre-mounted unframed mirrors already installed. These pre-mounted frameless mirrors are typically installed by the home-builder during the original construction, not for added decor value, but to meet the basic requirements for fixture standards.

Because of this, there are many pre-mounted frameless mirrors that can benefit from being enhanced with a custom installed mirror frame by a do-it-yourself (DIY) consumer wanting to complete a decorative mirror frame project.

However, the options for the do-it-yourself (DIY) consumer to easily and cost-effectively build and install a custom frame on an existing frameless pre-mounted mirror typically requires significant effort, skills, tools, proper transportation, and/or precise fabrication from remote third-party custom manufactures.

One DIY mirror framing option available today is to purchase all the raw materials and tools needed to measure, cut, paint, and install the mirror frame. This option involves a lot of time, effort, noise, dust, basic construction knowledge, tools, and painting supplies. Moreover, if each step is not completed properly, this option can result in an unprofessional looking mirror frame. Additionally, due to the typically long lengths of frame members needed of these solid frames, one must have suitable transportation, cargo room, and marker flags needed to transport the frame members to home or office.

Another option is for the consumer to purchase pre-finished mirror frames which the consumer can then cut, assemble, and install. However, such frames are heavy and awkward to transport in typical passenger vehicles. They are difficult to cut with precision, and then install without professional tools.

A further option is to custom order pre-cut mirror frames which are shipped to you for self-installation. Due to the custom work involved at the factory, there is a significant wait-time for the work scheduling, completion of fabrication, and final product shipment to the customer. Then at least two people are needed to install the mirror frame, due to the weight and bulk of a completed frame, and the precise positioning efforts needed to install it. Additionally, this option is prone to miscommunication and manufacturing errors, because it requires clear and precise information communicated from the customer to a remote third-party. There is the possibility that proper measurements of the mirror were not made or communicated correctly, leading to a defective or mismatched custom frame.

Yet another option is to hire professional mirror frame installers to custom-install a professional-looking frame. However, this is no longer a DIY project, but rather it is a DIFM (do-it-for-me) project option, which is also the most costly option.

### SUMMARY OF THE INVENTION

The invention is a decorative, compactable mirror frame for mirrors of nearly any size, including mirrors attached to a wall with clips, packageable within a conveniently-sized box that can be purchased “off-the-shelf”, easily transported by any typical personal vehicle, and then easily self-installed on most pre-mounted mirrors.

A general aspect of the invention is a mirror frame for adorning a mirror mounted to a wall. The mirror frame includes: at least four flexible frame members, each frame member capable of being rolled up, and each frame member having an adhesive backing strip on a back side of the frame member, such that a portion of the back side can be mounted upon the mirror.

In some embodiments, each frame member also has a cushioned channel extending alongside the adhesive backing strip. In further embodiments, the cushioned channel has cushion material for embedding a portion of at least one mirror clip protruding above a surface of the mirror mounted to the wall. In other further embodiments, the cushioned channel has cushion material that is at least one of: anti-microbial, anti-mold, anti-fungal, insect repellant.

In some embodiments, each frame member also has a decorative side.

Another general aspect of the invention is a mirror frame for adorning a mirror mounted to a wall, the mirror frame including: at least four segmented frame members, each frame member being capable of being separated into segments, and each frame member having an adhesive backing strip on a back side of the frame member, such that a portion of the back side can be mounted upon the mirror.

In some embodiments, each frame member also has a cushioned channel extending alongside the adhesive backing strip. In further embodiments, the cushioned channel has cushion material for embedding a portion of at least one mirror clip protruding above a surface of the mirror mounted to the wall. In other further embodiments, the cushioned channel has cushion material that is at least one of: anti-microbial, anti-mold, anti-fungal, insect repellant.

In some embodiments, each frame member also has a decorative side.

Another general aspect of the invention is a compact mirror frame kit, the kit including: at least four compacted frame members; a miter box; and a cutting tool.

In some embodiments, the compact mirror frame kit also includes a box for containing: the at least four compacted frame members; the miter box; and the cutting tool.

In some embodiments, the at least four compacted frame members being at least one of: segmented and flexible.

In some embodiments, the compact mirror frame kit also includes at least four corner blocks.

In some embodiments, the compact mirror frame kit also includes a measuring tape.

Another general aspect of the invention is a compact mirror frame kit, the kit including: at least four compacted frame members; and at least four corner blocks.

In some embodiments, the compact mirror frame kit also includes a box for containing: the at least four compacted frame members; and the at least four corner blocks.

In some embodiments, the compact mirror frame kit also includes a miter box; and a cutting tool.

Another general aspect of the invention is a frame member of a mirror frame for adorning a mirror mounted to a wall with mirror clips, the frame member having a cushioned channel, having cushion material for embedding at least one mirror clip, the cushioned channel extending along the frame member for accommodating clips of the mirror mounted to a wall with the clips, such that a back portion extending along the frame member can be mounted in flush relationship with the mirror, while another back portion extending along the frame member also extends over and beyond the clips, thereby embedding the clips within the cushion material of the cushioned channel.

In some embodiments, the frame member has an adhesive backing strip extending alongside the cushioned channel.

In some embodiments, the cushioned channel has cushion material that is at least one of: anti-microbial, anti-mold, anti-fungal, insect repellant.

In some embodiments, the cushioned channel is filled with a viscoelastic material.

In some embodiments, the frame member has a decorative side.

### BRIEF DESCRIPTION OF THE DRAWINGS

The invention will be more fully understood by reference to the Detailed Description, in conjunction with the following figures, wherein:

FIG. 1A is an oblique view of four rolled-up flexible members of a mirror frame of the invention, packaged with optional corner blocks, a cutting tool, and a miter box, entirely contained in a convenient cardboard box;

FIG. 1B is an oblique view of twenty (for example) connectable partial members (shown in four stacks of five partial members each) of a mirror frame of the invention, packaged with the optional corner blocks, a cutting tool, and a miter box, entirely contained in a convenient cardboard box;

FIG. 1C is an oblique view of a frame member in a flat state prior to cutting;

FIG. 1D is an oblique view of the frame member of FIG. 1C, after being cut using a miter box and a cooperative cutting tool;

FIG. 2A is an oblique view of a frame member in a fully rolled state with the adhesive side facing inward and the decorative side facing outward;

FIG. 2B is an oblique view of a frame member in a fully rolled state with the adhesive side facing outward and the decorative side facing inward;

FIG. 2C is a top view of a frame member in a flat state with the adhesive side (not shown) facing downward, and the decorative side facing upward;

FIG. 2D is an oblique view of a frame member showing an ornate decorative pattern on its decorative side;

FIG. 2E is an oblique view of a frame member showing a diamond decorative pattern on its decorative side;

FIG. 2F is an oblique view of a frame member showing an abutting rectangle decorative pattern on its decorative side;

FIG. 3A is an oblique view of a frame member in a partially rolled state with the adhesive side facing inward and the decorative side facing outward;

FIG. 3B is an oblique view of the frame member of 3A, flipped over;

FIG. 3C is an oblique view of a partially rolled frame member as shown in FIG. 3B, also showing a cushion channel for accommodating mirror clips;

FIG. 4A is an oblique view of a frame member in a flat state with the adhesive side facing upward, also showing a cushioned channel;

FIG. 4B is a side view of the frame member of FIG. 4A, showing the adhesive layer and the cushioned channel on the top, and showing a decorative relief pattern on the bottom;

FIG. 4C is a top view of an unrolled frame member, showing the decorative side;

FIG. 4D is a bottom view of the unrolled frame member of FIG. 4C, showing the adhesive side, also showing a cushion channel for accommodating mirror clips;

FIG. 5 is a side view of a frame member of the invention, the frame member having a cushion channel that is accommodating a mirror clip that is screwed into a wall;

FIG. 6 is an oblique view of two connectable partial frame members, aligned and joined by a joining element that is inserted into the cushion gap of each partial frame member, so as to form a frame member;

FIG. 7A is a top view of three connectable partial frame members of FIG. 1B having an abutting rectangle decorative pattern on its decorative side;

FIG. 7B is a top view of three connectable partial frame members of FIG. 1B having gem decorative pattern on its decorative side;

FIG. 7C is top view of three connectable partial frame members showing a rounded pebble decorative pattern on its decorative side;

FIG. 7D is top view of three connectable partial frame members showing an antique floral decorative pattern on its decorative side;

FIG. 8A is an oblique view of a mirror attached to a wall with mirror clips, showing two flexible frame members fixed in place, and a third flexible frame member in the process of being fixed in place, all flexible frame members having mitered ends;

FIG. 8B is an oblique view of a mirror attached to a wall with mirror clips, showing two mirror frame members assembled from a plurality of partial frame members and fixed in place, and a third mirror frame member in the process of being assembled and fixed in place, all assembled frame members having mitered ends;

FIG. 9 is a front view of a mirror attached to a wall over a sink cabinet, with all frame members being fixed in place, joined using four corner elements instead of mitered ends;

FIG. 10A is a front view of a mirror with four frame members joined using four corner elements;

FIG. 10B is a front view of a mirror with four frame members joined with mitered ends;

FIG. 10C is a front view of a mirror with four frame members joined with abutting ends;

FIG. 11 is an oblique view of a frame member in a partially rolled state, the frame member having periodic transverse notches on the adhesive side;

FIG. 12 is an oblique view of a frame member in a folded state;

FIG. 13A is an oblique view of the box of FIGS. 1A and 1B;

FIG. 13B is a top view of the rolled-up flexible frames of FIG. 1A;

FIG. 13C is a top view of the frame segments of FIG. 1B, showing three example decorative patterns;

FIG. 13D is a top view of the four corner blocks of FIGS. 1A and 1B;

FIG. 13E is an oblique view of the miter box of FIGS. 1A and 1B; and

FIG. 13F is an oblique view of the cutting tool of FIGS. 1A and 1B.

### DETAILED DESCRIPTION

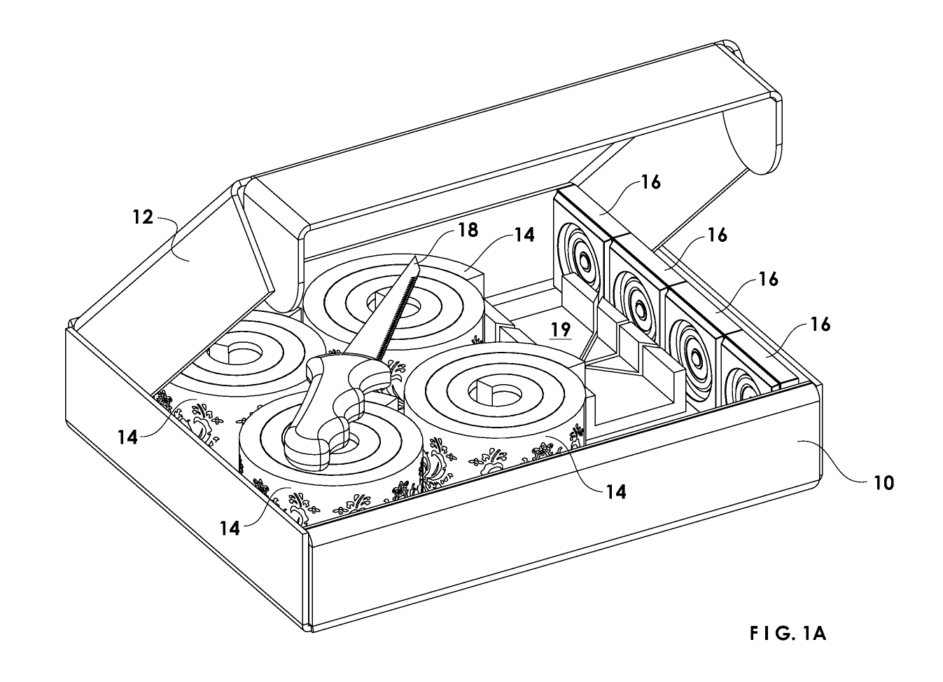

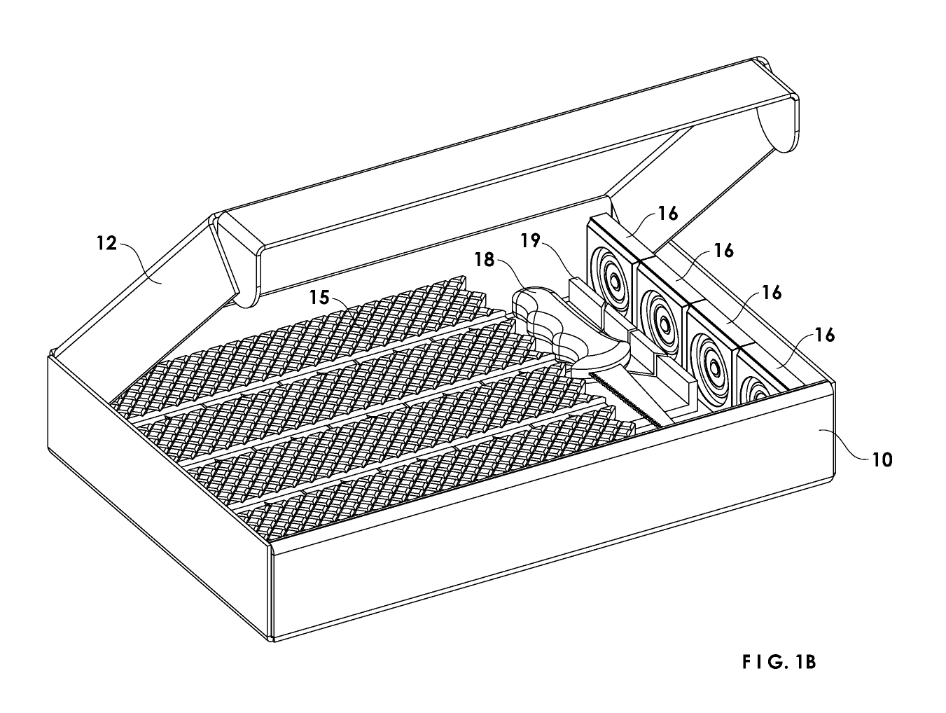

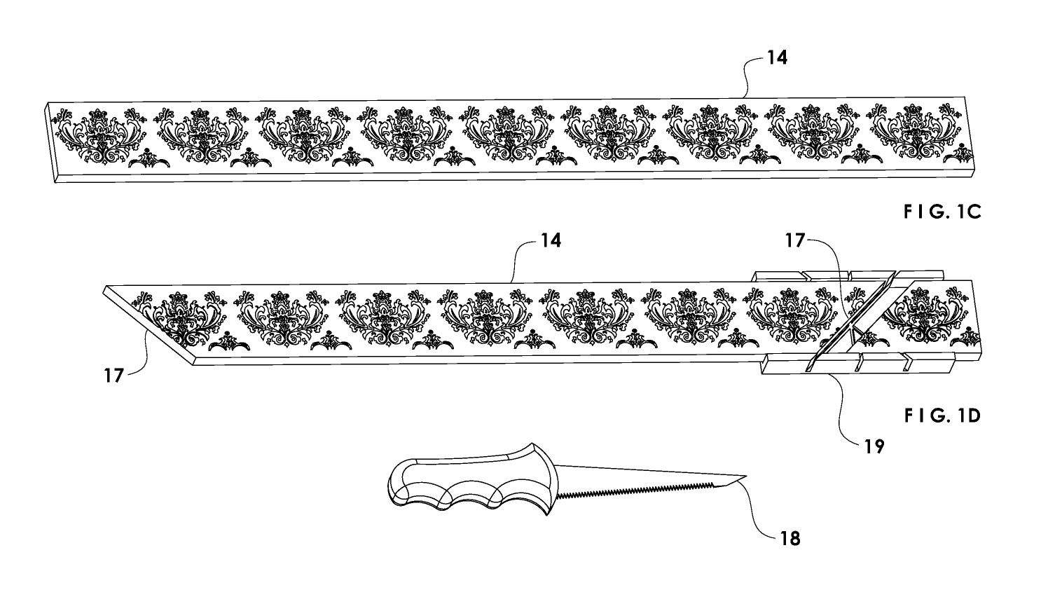

With reference to FIG. 1A, a cardboard box 10 with its top flap 12 open contains: four rolled-up flexible frame members 14, four optional corner elements 16, a cutting tool 18, and a miter box 19. Instructions (not shown) can also be included. When purchased at the store, the box 10 is closed and sealed, and can be easily carried to the car for transportation to home or office.

FIG. 1B is an oblique view of twenty connectable partial frame members 15 (shown in four stacks of five partial frame members each) of a mirror frame of the invention, packaged with the optional corner elements 16, a cutting tool 18, and a miter box 19, entirely contained in a convenient cardboard box 10 as in FIG. 1A. The connectable partial frame members 15 can be either flexible (made from rubber, densified foam, or rubberized plastic) or rigid (made from wood, rigid plastic, or natural and/or synthetic composite).

Referring to FIG. 1C, a flexible frame member 14 is shown in a flat state after being unrolled, and before being cut to size and/or before being given a mitered end.

Referring to FIG. 1D, the frame member 14 of FIG. 1C is shown after being cut using a miter box 19 and a cooperative cutting tool 18, so as to create mitered ends 17.

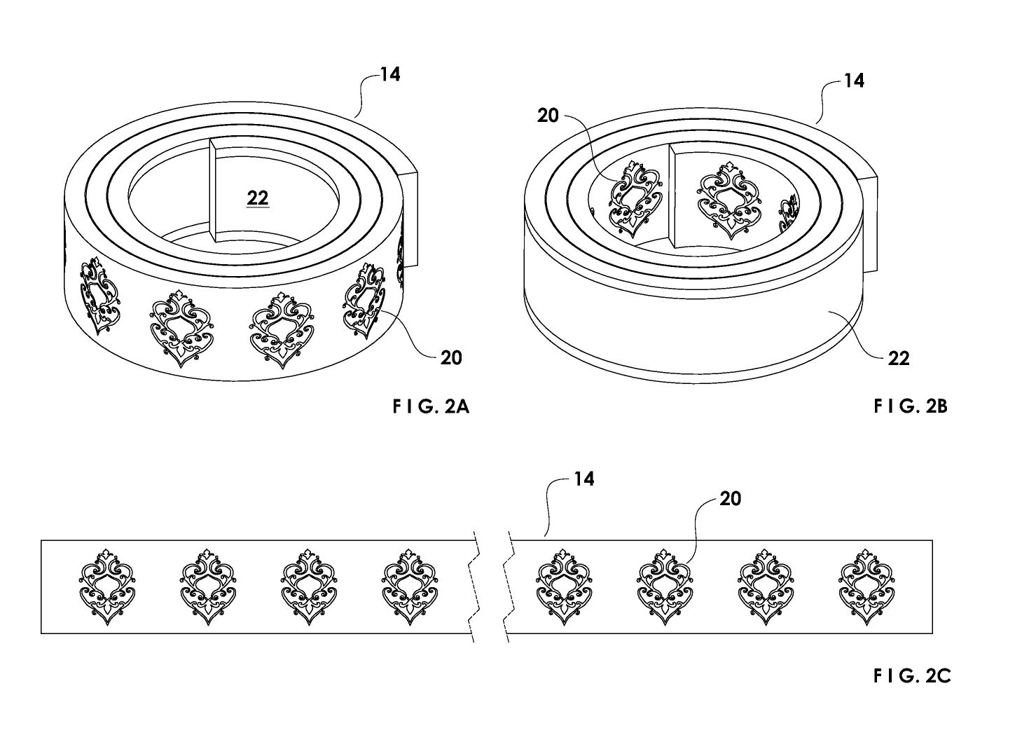

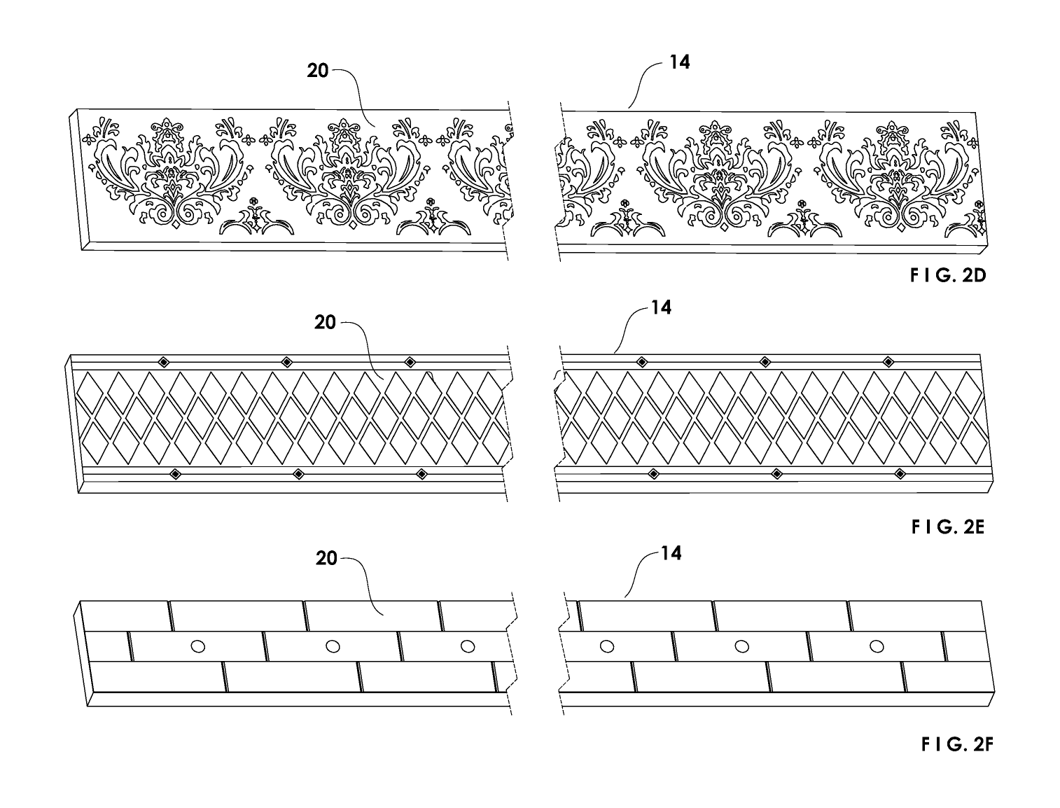

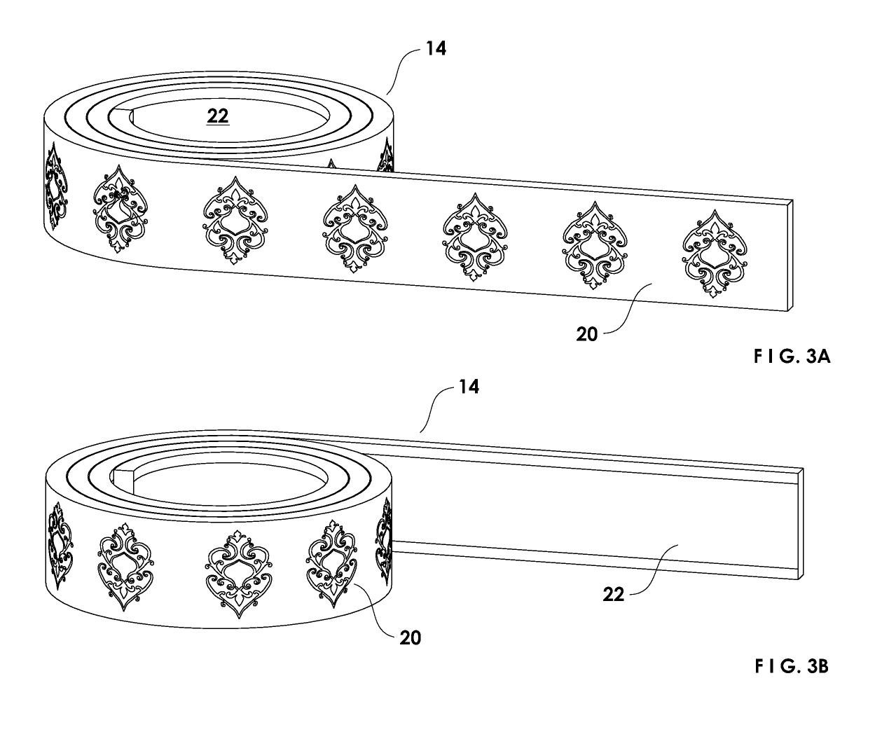

Referring to FIG. 2A, a flexible frame member 14 in a rolled state is shown, where the flexible frame member 14 is rolled so as to have the decorative side 20 facing outward, and the adhesive side 22 facing inward.

Referring to FIG. 2B, a flexible frame member 14 in a rolled state is shown, where the flexible frame member 14 is rolled so as to have the adhesive side 22 facing outward, and the decorative side 20 facing inward.

Referring to FIG. 2C, a flexible frame member 14 in a flat state is shown with the adhesive side (not shown) facing downward, and the decorative side 20 facing upward.

Referring to FIG. 2D, a flexible frame member 14 having an ornate decorative pattern on its decorative side 20 is shown.

Referring to FIG. 2E, a frame member 14 having a diamond decorative pattern on its decorative side 20 is shown.

Referring to FIG. 2F, a frame member 14 having an abutting rectangle decorative pattern on its decorative side 20 is shown.

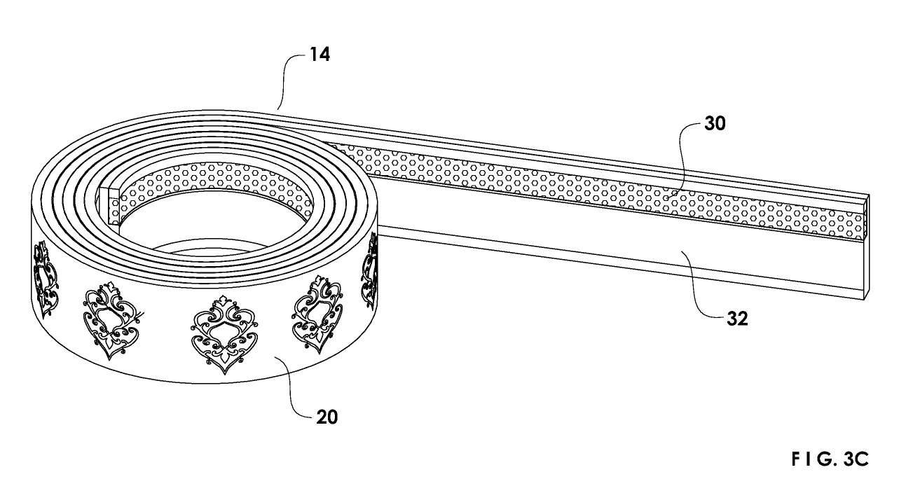

Referring to FIG. 3A, a flexible frame member 14 is shown in a partially rolled state with the adhesive side 22 facing inward and the decorative side 20 facing outward.

Referring to FIG. 3B, the flexible frame member 14 of 3A is shown, flipped over, also showing the adhesive side 22 facing inward and the decorative side 20 facing outward.

Referring to FIG. 3C, a partially rolled flexible frame member 14 as shown in FIG. 3B, has a decorative side 20, and on the oppose side has an adhesive area 32. Additionally, the flexible frame member 14 includes a cushion channel 30 for accommodating mirror clips.

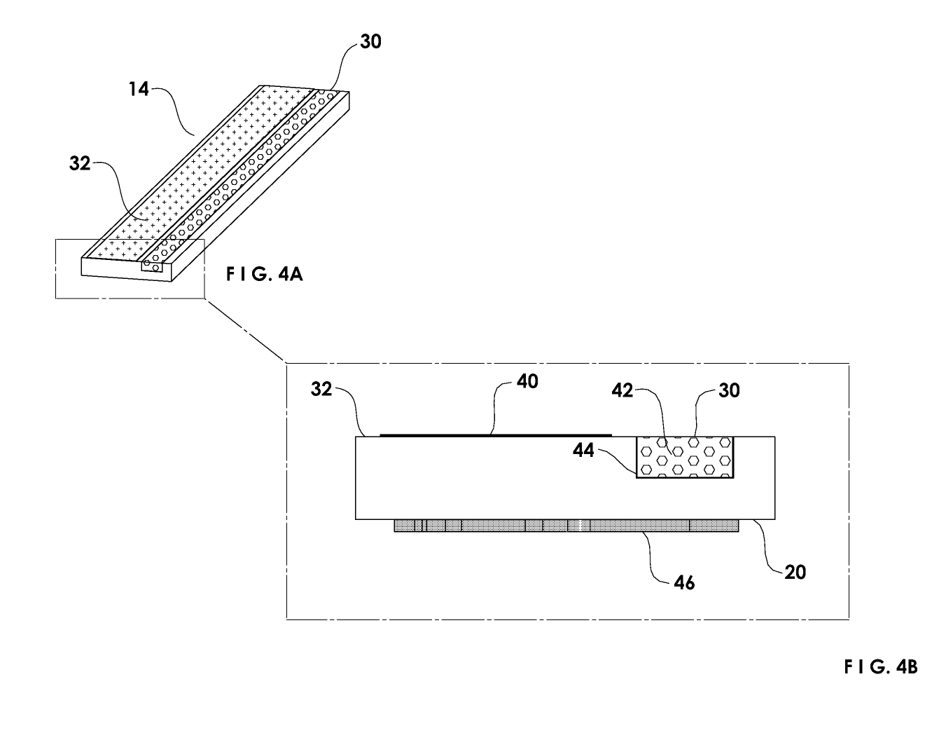

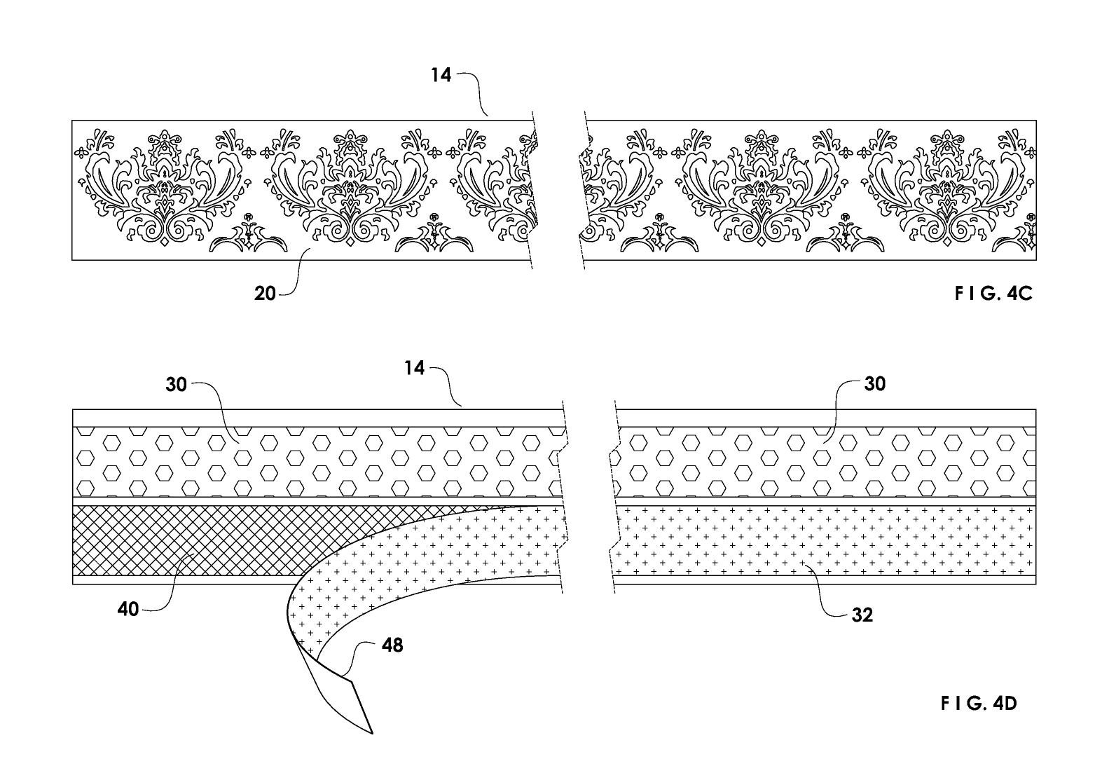

Referring to FIG. 4A, a frame member 14 as shown in FIG. 3C is in a flat state with the adhesive area 32 facing upward, also showing the cushioned channel 30. The frame member 14 of FIG. 4A could be either flexible or rigid.

FIG. 4B shows a cross-section of the frame member 14 of FIG. 4A, showing the adhesive area 32 having an adhesive layer 40, and showing the cushion channel 30 having cushion material 42 filling a longitudinal channel 44. The decorative side 20 shows a decorative relief pattern 46. The cushion material 42 of the cushioned channel 30 helps to exclude bugs and prevent dust from collecting in what is typically an empty space (except for the small portions that accommodate mirror clips), and thus be a place where disease organisms can find a protected home and begin to create airborne allergens and pathogens. The cushion material 42 can also serve to protect the frame material from moisture damage, mold growth (such as toxic black mold), insect nesting, etc. The cushion material 42 can be made from: closed-cell foam, open-cell foam, fiber-glass, vinyl, and/or hydrophobic plastic. The cushion material 42 can also include anti-microbial agents, mold inhibitors, anti-fungal agents, and/or insect repellants.

With reference to FIG. 4C, a top view of a frame member 14 is shown, also showing the decorative side 20.

With reference to FIG. 4D, a bottom view of the frame member 14 of FIG. 4C is presented, showing the adhesive area 32, also showing the cushion channel 30 for accommodating mirror clips, and a peel-away strip 48 that reveals the adhesive layer 40 of the adhesive area 32.

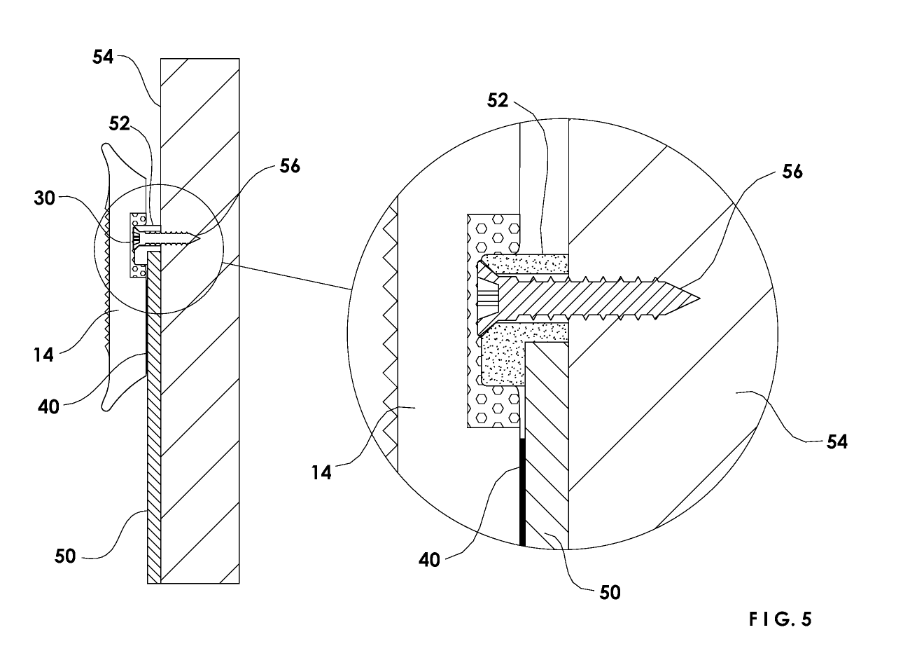

Referring to FIG. 5, a frame member 14 of FIGS. 4A and 4B is shown in side view, the frame member 14 adhering to the mirror 50 via the adhesive layer 40, the flexible frame member 14 having a cushion channel 30 that is accommodating a mirror clip 52 that is screwed into a wall 54 via a screw 56.

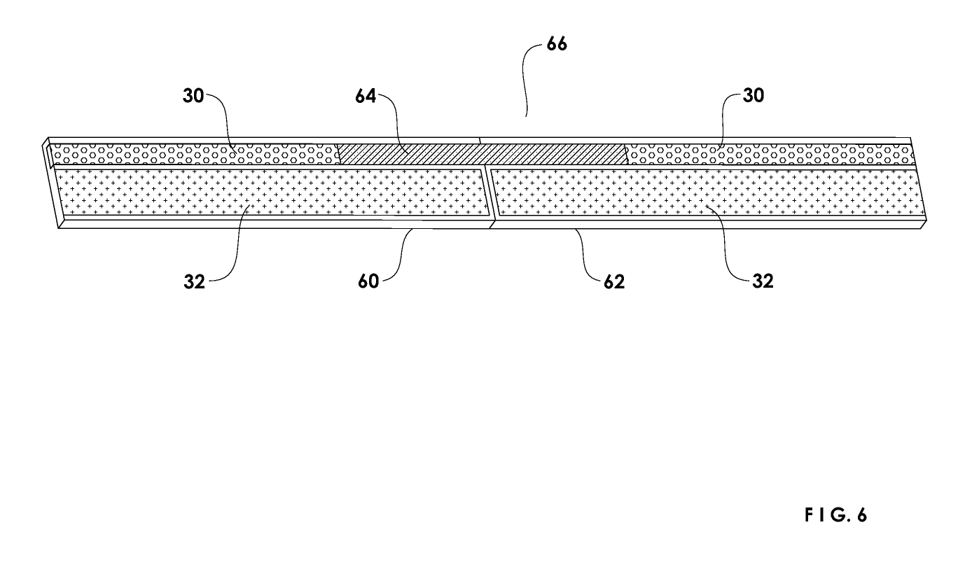

Referring to FIG. 6, two connectable partial frame members 60 and 62 (like the connectable partial frame member 15 as shown in FIG. 1B) are joined by a joining element 64 being inserted into the cushion channel 30 of each partial frame member 60, 62 so as to form a compound frame member 66. The joining element 64 also functions to align the partial frame members 60, 62. Thus, the joining element 64 helps to both join and align each of the connectable partial frame members to neighboring connectable partial frame members. This embodiment also includes alongside the cushion channel 30, an adhesive area 32. Further sections can be connected in like manner to either partial frame member 60 or 62 so as to create a compound frame member of whatever length is required. One advantage of this embodiment is that many sections can be conveniently included in a box such as the box 10 of FIG. 1B. The partial frame members 60 and 62 can be rigid or flexible. The joining element 64 can be either rigid or flexible, a rigid joining element being recommended for joining flexible partial frame members, and a flexible joining element being recommended for joining rigid partial frame members.

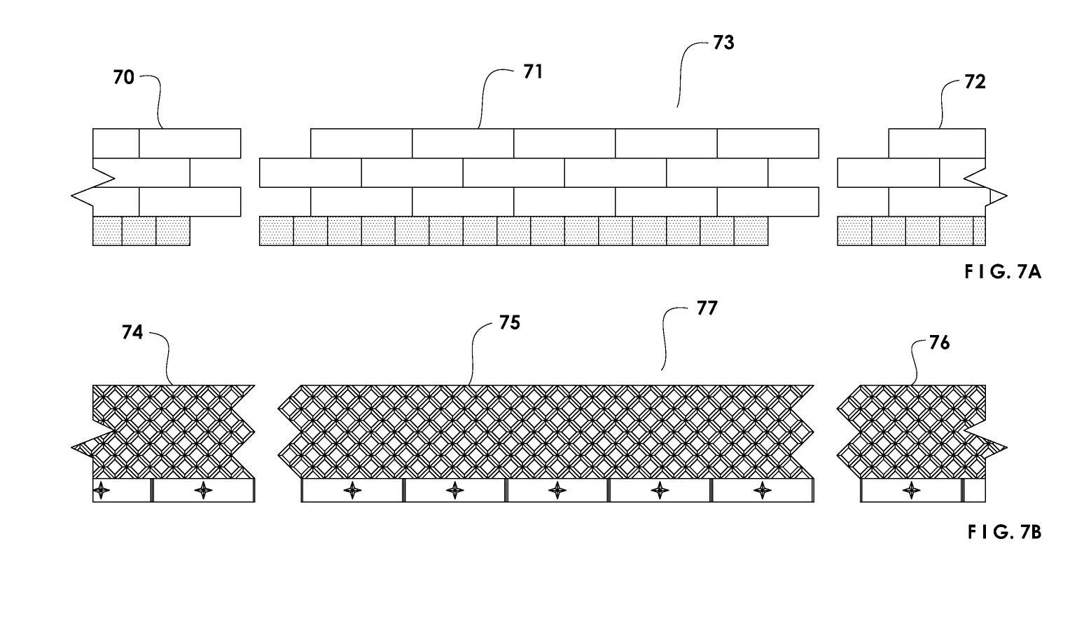

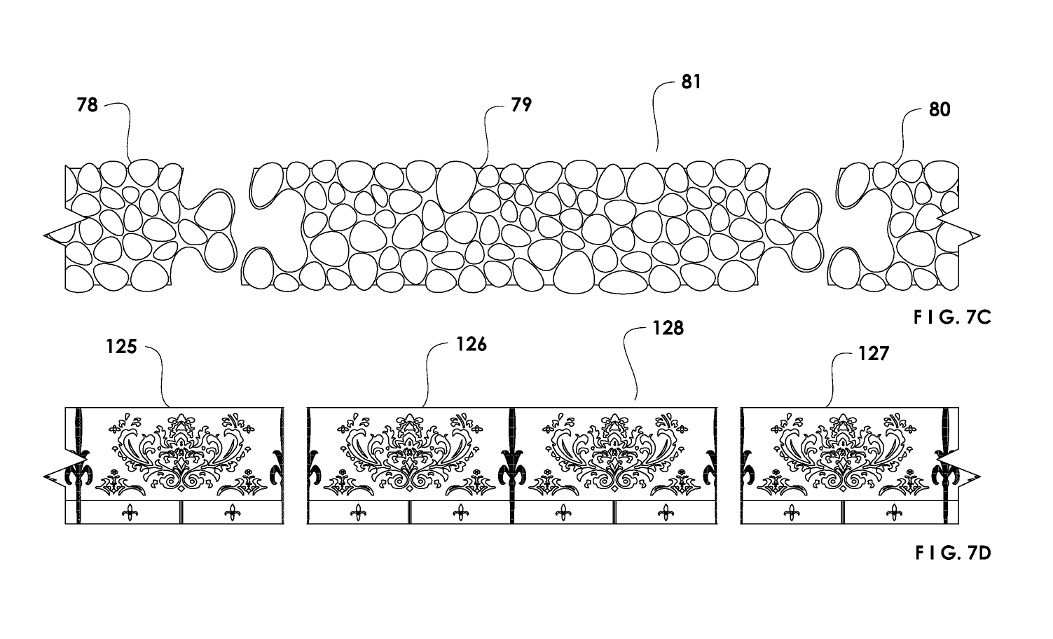

FIG. 7A is a top view of three connectable partial frame members 70, 71, 72 having an abutting rectangle decorative pattern on its decorative side that does NOT need to be joined by a joining element (not shown) cooperative with a cushion channel on the reverse side of each of the partial frame members 70, 71, 72 so as to form a compound frame member 73. A joining element is not needed to connect the partial frame members because the interdigitating shape of each end of each partial frame member performs sufficient alignment of the connected partial frame members.

FIG. 7B is a top view of three connectable partial frame members 74, 75, 76 having gem decorative pattern on its decorative side joined so as to form a compound frame member 77. A joining element is not needed to connect the partial frame members because the interdigitating shape of each end of each partial frame member performs sufficient alignment of the connected partial frame members.

FIG. 7C is a top view of three connectable partial frame members 78, 79, 80 having a rounded pebble decorative pattern on its decorative side joined so as to form a compound frame member 81. A joining element is not needed to connect the partial frame members because the interlocking shape of each end of each partial frame member performs sufficient alignment of the connected partial frame members.

FIG. 7D is a top view of three connectable partial frame members 125, 126, 127, each having an antique floral decorative pattern on its decorative side, and each juxtaposed so as to form a compound frame member 128. The partial frame members 125, 126, 127 when abutting against one another also form a continuous antique floral decorative pattern. Alignment of the partial frame members of each frame member can be achieved using a joining element to join each partial frame member to its neighbor(s) and/or using a straight-edge placed temporarily alongside all of the partial frame members so that a side edge of each of the partial frame members becomes pressed against, and thereby aligned with, the straight-edge.

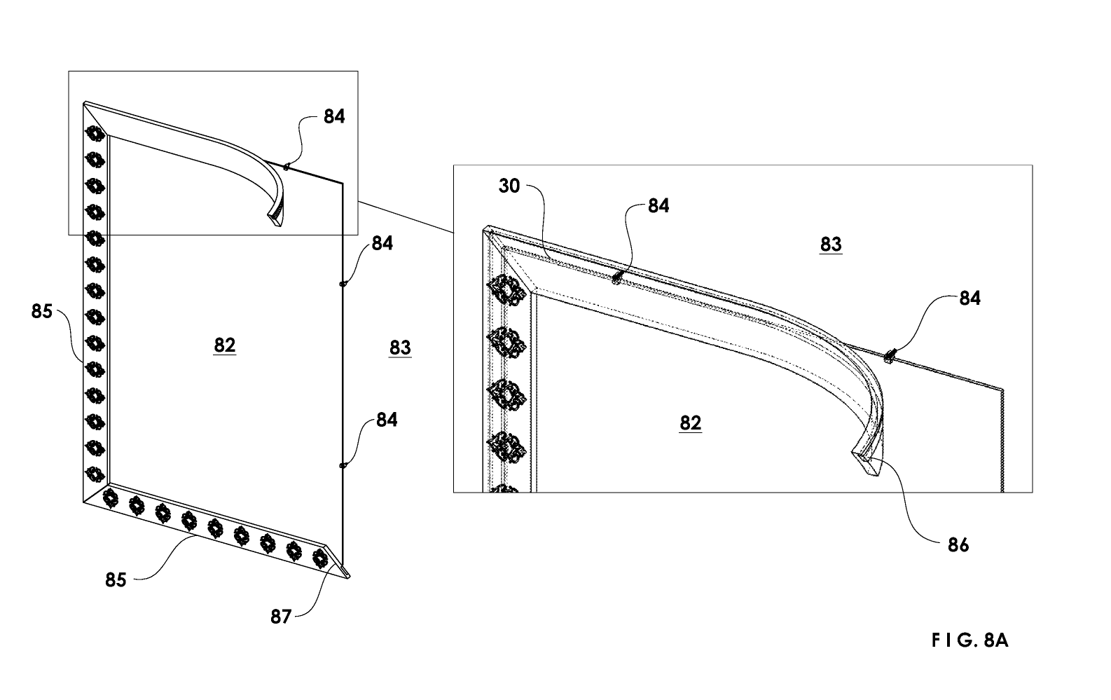

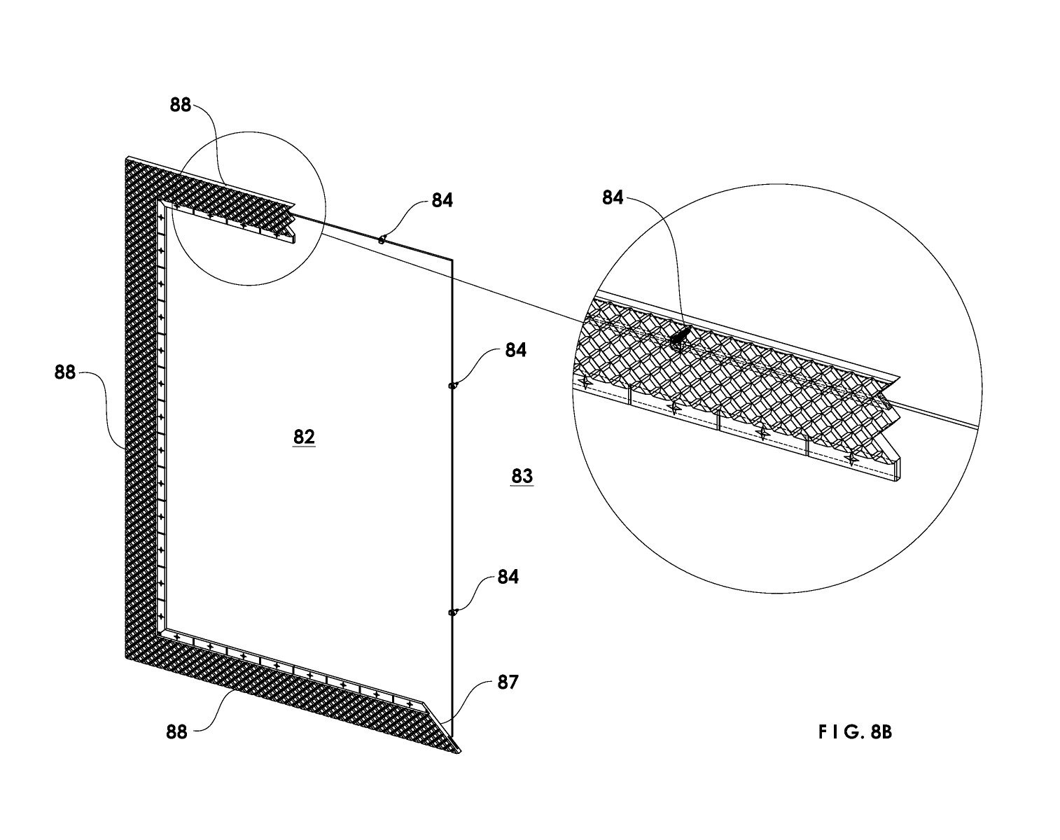

Referring to FIG. 8A, a mirror 82 is attached to a wall 83 with mirror clips 84, showing two flexible mirror frame members 85 fixed in place, and a third flexible mirror frame member 86 in the process of being fixed in place, all frame members 85, 86 having mitered ends 87. The flexibility of the frame members makes it easy to align the cushioned channel 30 (shown as dotted lines on the back of each frame member) with the mirror clips 84 so as to allow the frame element to be pressed flatly against the mirror 82 and the wall 83 all along the length of each frame element. A fourth flexible frame member (not shown) will be used to complete the flexible mirror frame of the mirror 82.

FIG. 8B is an oblique view of a mirror 82 attached to a wall 83 with mirror clips 84, showing two mirror frame members 88 assembled and fixed in place, and a third mirror rigid frame member 89 in the process of being assembled and fixed in place, all assembled rigid frame members having mitered ends 87. A joining element is not needed to connect the partial frame members because the interdigitating shape of each end of each partial frame member performs sufficient alignment of the connected partial frame members.

FIG. 9 provides a front view of a mirror 90 attached to a wall 92 over a sink cabinet 94, with all (rigid or flexible) frame members 96 being fixed in place, joined using four corner elements 98 instead of mitered ends.

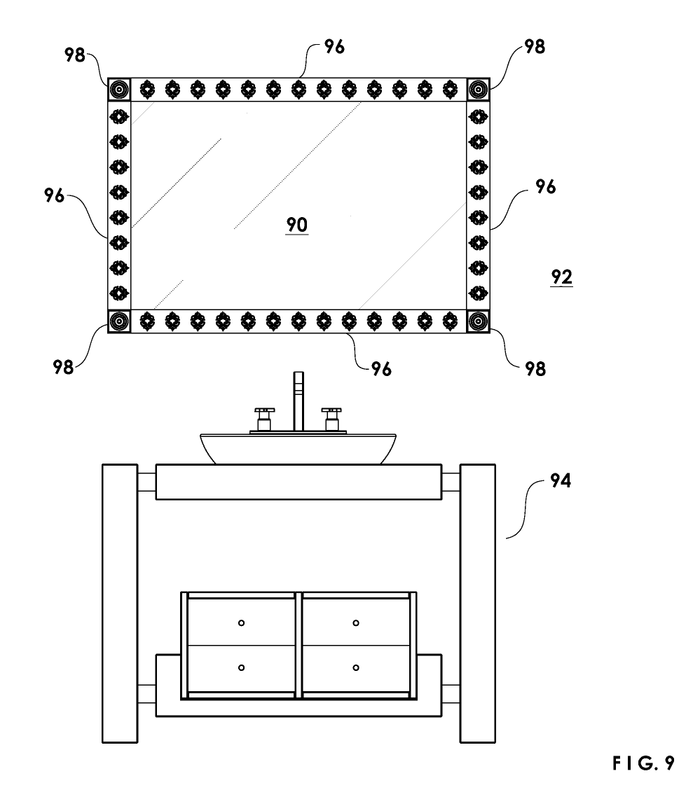

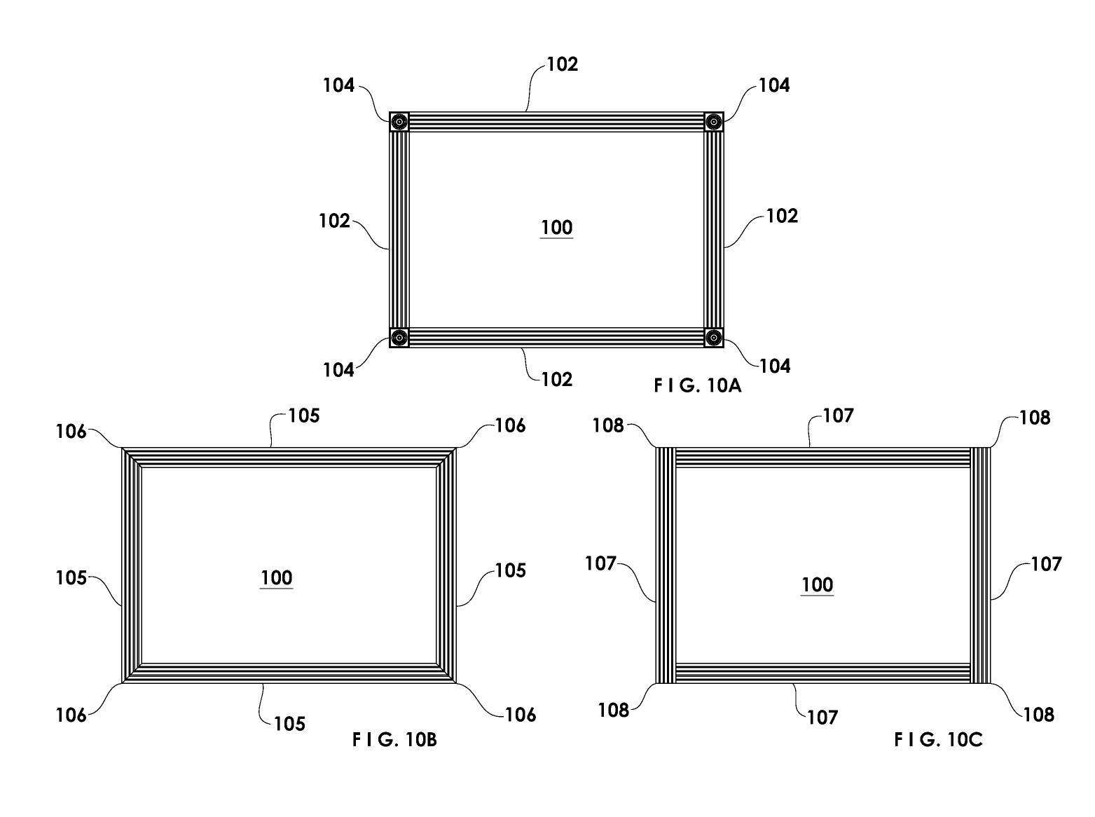

FIG. 10A provides a front view of a mirror 100 with four (rigid or flexible) frame members 102 joined using four corner elements 104.

FIG. 10B provides a front view of a mirror 100 with four (rigid or flexible) frame members 105 joined with mitered ends 106.

FIG. 10C provides a front view of a mirror 100 with four (rigid or flexible) frame members 107 joined with perpendicular abutting ends 108.

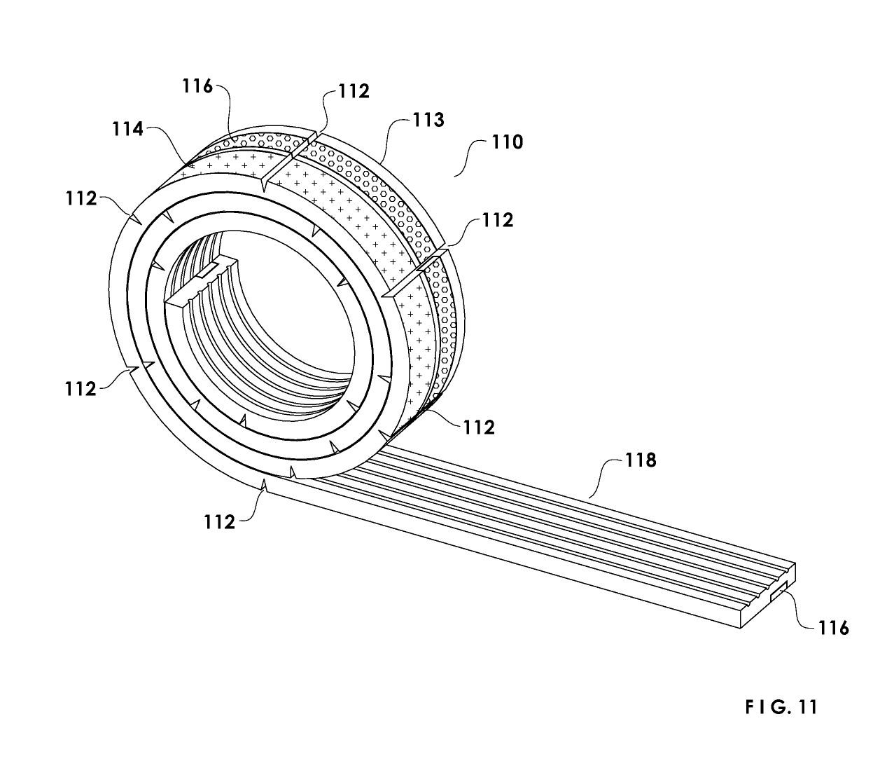

With reference to FIG. 11, a flexible frame member 110 in a partially rolled state is shown, the frame member 110 having periodic transverse notches 112 on the adhesive side 113, the adhesive side including an adhesive area 114 and a cushioned channel 116. This flexible frame member 110 also has a decorative side 118.

FIG. 12 is an oblique view of a flexible frame member 120 in a folded state, having an adhesive side 122, and a decorative side 124. Folding a flexible frame member can help it to fit inside a box, such as the box 10 of FIG. 1A.

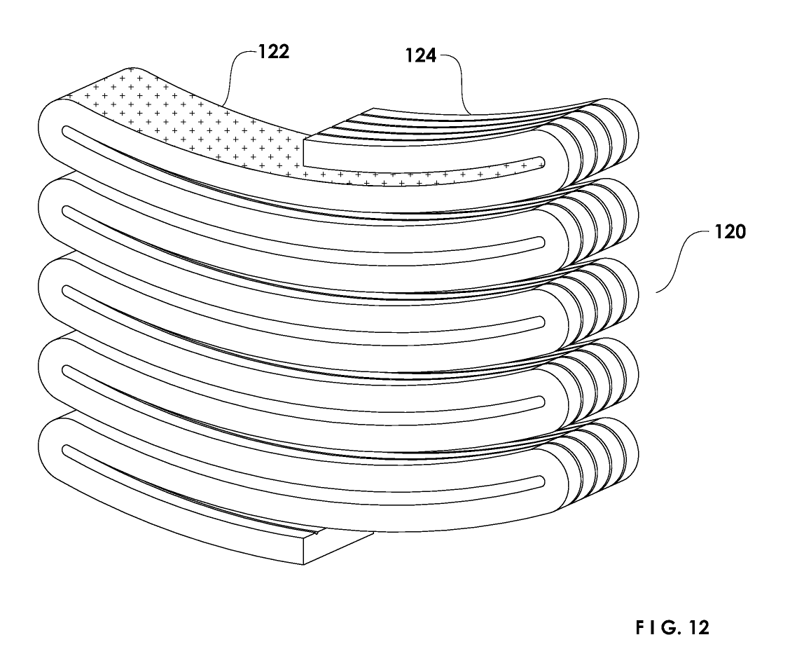

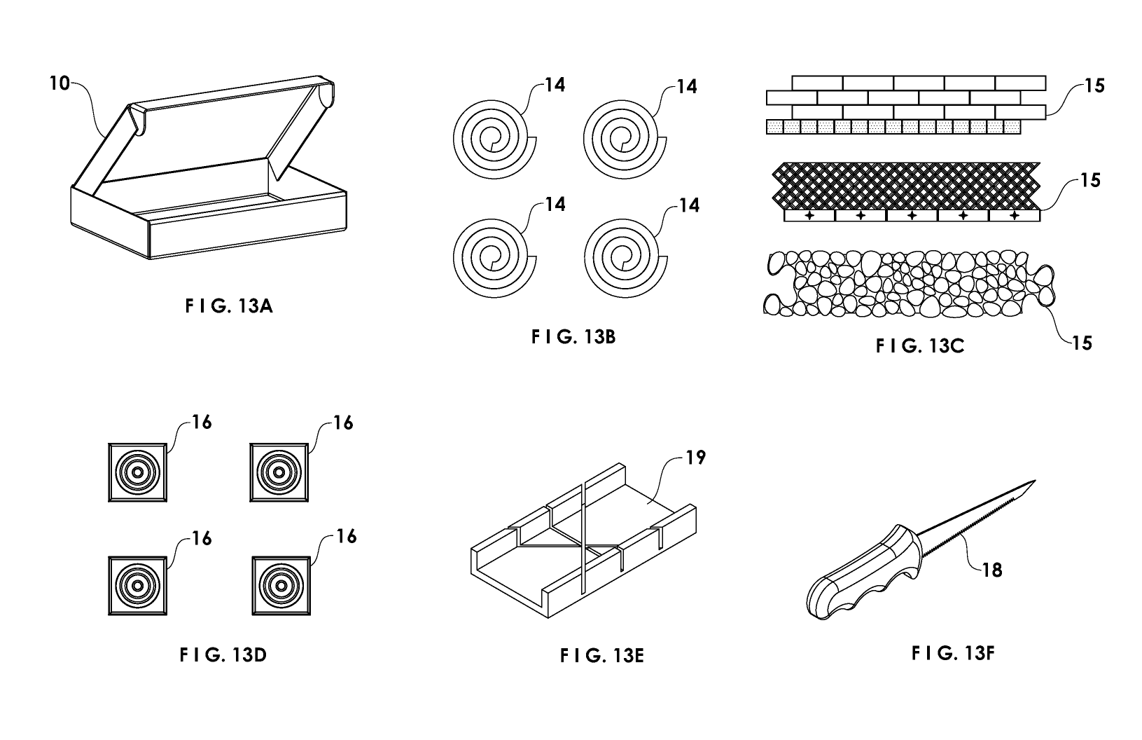

FIG. 13A is an oblique view of the box 10 of FIGS. 1A and 1B.

FIG. 13B is a top view of the rolled-up flexible frames 14 of FIG. 1A.

FIG. 13C is a top view of the frame segments (flexible or rigid) 15 of FIG. 1B, showing three example decorative patterns.

FIG. 13D is a top view of the four corner blocks 16 of FIGS. 1A and 1B.

FIG. 13E is an oblique view of the miter box 19 of FIGS. 1A and 1B.

FIG. 13F is an oblique view of the cutting tool 18 of FIGS. 1A and 1B.

Other modifications and implementations will occur to those skilled in the art without departing from the spirit and the scope of the invention as claimed. Accordingly, the above description is not intended to limit the invention except as indicated in the following claims.

What is claimed is:

1. A mirror frame for adorning a mirror mounted to a wall, the mirror frame comprising:
at least four flexible frame members,
each frame member capable of being rolled up,
each frame member having an adhesive backing strip on a back side of the frame member,
such that a portion of the back side can be mounted upon the mirror.

2. The mirror frame of claim 1, each frame member also having a cushioned channel extending alongside the adhesive backing strip.

3. The mirror frame of claim 2, the cushioned channel having cushion material for embedding a portion of at least one mirror clip protruding above a surface of the mirror mounted to the wall.

4. The mirror frame of claim 2, the cushioned channel having cushion material that is at least one of: anti-microbial, anti-mold, anti-fungal, insect repellant.

5. The mirror frame of claim 1, each frame member also having a decorative side.

6. A mirror frame for adorning a mirror mounted to a wall, the mirror frame comprising:
at least four segmented frame members,
each frame member being capable of being separated into segments,
each frame member having an adhesive backing strip on a back side of the frame member,
such that a portion of the back side can be mounted upon the mirror.

7. The mirror frame of claim 6, each frame member also having a cushioned channel extending alongside the adhesive backing strip.

8. The mirror frame of claim 7, the cushioned channel having cushion material for embedding a portion of at least one mirror clip protruding above a surface of the mirror mounted to the wall.

9. The mirror frame of claim 7, the cushioned channel having cushion material that is at least one of: anti-microbial, anti-mold, anti-fungal, insect repellant.

10. The mirror frame of claim 6, each frame member also having a decorative side.

11. A compact mirror frame kit, the kit comprising:
at least four compacted frame members;
a miter box; and
a cutting tool.

12. The compact mirror frame kit of claim 11, further comprising:
a box for containing:
the at least four compacted frame members;
the miter box; and
the cutting tool.

13. The compact mirror frame kit of claim 11,
the at least four compacted frame members being at least one of:
segmented and flexible.

14. The compact mirror frame kit of claim 11, further comprising:
at least four corner blocks.

15. The compact mirror frame kit of claim 11, further comprising:
a measuring tape.

16. A compact mirror frame kit, the kit comprising:
at least four compacted frame members; and
at least four corner blocks.

17. The compact mirror frame kit of claim 16, further comprising:
a box for containing:
the at least four compacted frame members; and
the at least four corner blocks.

18. The compact mirror frame kit of claim 16, further comprising:
a miter box; and
a cutting tool.

19. A frame member of a mirror frame for adorning a mirror mounted to a wall with mirror clips, the frame member comprising:
a cushioned channel,
the cushioned channel having cushion material for embedding at least one mirror clip,
the cushioned channel extending along the frame member for accommodating clips of the mirror mounted to a wall with the clips,
such that a back portion extending along the frame member can be mounted in flush relationship with the mirror,
while another back portion extending along the frame member also extends over and beyond the clips,
thereby embedding the clips within the cushion material of the cushioned channel.

20. The frame member of claim 19, the frame member having an adhesive backing strip extending alongside the cushioned channel.

21. The frame member of claim 19, the cushioned channel having cushion material that is at least one of: anti-microbial, anti-mold, anti-fungal, insect-repellant.

22. The frame member of claim 19, the cushioned channel being filled with a viscoelastic cushion material.

23. The frame member of claim 19, the frame member also having a decorative side.
